(19) United States
(12) Patent Application Publication
(10) Pub. No.: US 2023/0346624 A1
(43) Pub. Date: Nov. 2, 2023

(54) DEVICE FOR POSITIONING A PERSON'S HEAD IN PREPARATION FOR A TREATMENT AND METHOD OF USE THEREOF

(71) Applicant: Neuro Spinal Innovation Inc., Mississauga (CA)

(72) Inventor: Aslam KHAN, Mississauga (CA)

(73) Assignee: Neuro Spinal Innovation Inc., Mississauga, ON (CA)

(21) Appl. No.: 18/300,271

(22) Filed: Apr. 13, 2023

Related U.S. Application Data
(60) Provisional application No. 63/335,551, filed on Apr. 27, 2022.

(51) Int. Cl. A61G 13/12

(52) U.S. Cl. CPC A61G 13/121; A61G 13/129

(57) ABSTRACT

A head positioner is provided for correctly positioning a patient’s head, the head positioner configured for use with a stand, the head positioner comprising: a platform which is configured to be mounted on the stand; a slider which is in slidable engagement with the platform, the slider movable longitudinally; a bracket which is mounted on the slider or is integral with the slider; and a landmark pad, the landmark pad including a pin which is in rotational engagement with the bracket, and a central depression or a central aperture for accepting a selected landmark of a patient’s head.

### CROSS REFERENCE TO RELATED APPLICATIONS

This application claims priority to U.S. Provisional Application Serial No. 63/335,551, filed Apr. 27, 2022, entitled “DEVICE FOR POSITIONING A PERSON’S HEAD IN PREPARATION FOR A TREATMENT AND METHOD OF USE THEREOF”. The above-identified priority patent application is incorporated herein by reference in its entirety.

### FIELD

The present technology is related to a head positioner that includes a platform, a yoke and a landmark cushion. More specifically, it is a head positioner that is adjustable in three linear directions in addition to three rotational directions, allowing for highly accurate positioning of a person’s head.

### BACKGROUND

There are many treatments that require accurate positioning of a user or patient’s head. For example, in chiropractic treatments, surgery, acupuncture and needling. Other treatments such as massage therapy, physiotherapy and athletic therapy, to name a few could benefit from accurate positioning. For this reason, there are numerous headrests and head restraints in the literature.

U.S. Pat. Application Publication No. 20040017099 discloses an articulated headrest. In one embodiment, an apparatus includes a base portion and a headrest portion, and the headrest portion is coupled to the base portion by an articulation mechanism which moves the headrest substantially along an arc defined with respect to a pivot point outside the headrest portion and the base portion. In some embodiments, the pivot point may approximate the cervicothoracic junction of a user. In some embodiments, the headrest portion may be used to maintain the user’s head in a substantially neutral position. In some embodiments, the headrest portion may be deployed in the event of a crash condition and/or may articulate in response to reclining a seat back. In one embodiment, a portable or pillow version may articulate a headrest portion with respect to a base portion to provide head support. This headrest is best suited for use in a vehicle and therefore is designed for such an application. It is not designed to accurately position a patient or user’s head in preparation for a treatment.

U.S. Pat. Application Publication No. 20020170116 discloses a surgical table apparatus for supporting a patient before, during, or after a surgical procedure. The surgical table apparatus includes a base and a tabletop. The tabletop includes a body support section adapted to support the body of a patient and a head support section adapted to support the head of a patient. The head support section is not designed to accurately position a patient or user’s head in preparation for a treatment.

U.S. Pat. Application Publication No. 20150283018 discloses an adjustable device that provides support and stabilization for a patient’s head during surgical procedures, especially ophthalmologic ones. A frame, including a base and lateral panel, allows an adjustable lateral support and locking mechanism to be engaged with each other and the frame. The adjustable lateral support consists of an elongated member, which is placed through a hole of the lateral panel, and a connected head bracing structure. A first cushioning pad and a second cushioning pad are secured to the base and the head bracing structure, respectively. The locking mechanism uses a spring which pushes a handle against the elongated member. The elongated member traverses through a slot of the handle; when the handle is pressed against the elongated member, the slot applies pressure against the elongated member and prevents movement. The handle can be lifted to allow the elongated member and thus head bracing structure to be repositioned. The head support section is not designed to accurately position a patient or user’s head in preparation for a treatment.

U.S. Pat. Application Publication No. 20150054326 discloses a headrest assembly for a chair that includes a headrest unit, two spaced-apart grip frame members respectively connected to two opposite ends of the headrest unit, and two spaced-apart connection frame members respectively connected to the grip frame members. The grip frame members gradually extend away from each other from the headrest unit to the connection frame members, respectively. Each of the grip frame members extends obliquely, rearwardly and downwardly from the headrest unit in a manner of being oblique to a first vertical plane that has opposite front and rear surfaces respectively facing front and rear sides of the chair. The headrest is minimally adjustable. The headrest is not designed to accurately position a patient or user’s head in preparation for a treatment.

U.S. Pat. Application Publication No. 20140145488 discloses an improved adjustable chair headrest. Specifically, the present invention comprises a double articulating dental chair headrest apparatus which has a one-handed side pushbutton release and locking mechanism. When pressed, the pushbutton temporarily disengages a movable mating plate having splined perforations away from each of two corresponding rotatable splined pin assemblies to unlock each splined pin assembly. The unlocked splined pin assemblies each rotate independently. Each splined pin assembly is also fixedly attached to one of a headrest and a backrest via an attachment plate. The two splined pin assemblies are held in relation to each other, the movable mating plate having splined perforations, and the side pushbutton release and locking mechanism, by a housing component. The headrest is independent of the dentist chair and can be rotated to help position the patient’s head. However, the headrest is minimally adjustable and is not designed to accurately position a patient or user’s head in preparation for a treatment.

U.S. Pat. Application Publication No. 20140096322 discloses a headrest assembly that includes a frame, a first head support configured and dimensioned to support a forehead of a patient, and a second head support configured and dimensioned to support a chin of the patient. An adjustment mechanism is mounted to the frame and is operable to adjust the position of at least one of the first and second head supports relative to the frame. The first and second head supports having at least two degrees of freedom relative to a longitudinal plane and at least one degree of freedom relative to an axial plane that is orthogonal to the longitudinal plane. The longitudinal plane extends parallel to an X axis and also extends parallel to a Y axis that is orthogonal to the X axis. The axial plane extends parallel to one of the X axis and the Y axis. The axial plane also extends parallel to a Z-axis that is orthogonal to both the X axis and the Y axis. While these head supports can be adjusted, they are overly complex and could result in the patient’s head being improperly placed as the two head supports can be adjusted individually.

U.S. Pat. Application Publication No. 20050184573 discloses a mechanism for supporting and permitting selected adjustment of the position of a headrest relative to the back of a chair comprises a body, a first pivotable connection, a second pivotable connection and a selectively releasable locking mechanism. The first pivotable connection is near the first end of the body, adapted to connect to the chair and to allow pivoting of the body relative to the chair. The second pivotable connection is near the second end of the body, adapted to connect to the headrest and to allow pivoting of the headrest relative to the body. The selectively releasable locking mechanism is configured to retain the body in selected angular positions relative to the chair and relative to the headrest by clamping together interleaved plate members in frictional contact and to allow for one-handed actuation. The adjustment is limited therefore the headrest and mechanism are not designed to accurately position a patient or user’s head in preparation for a treatment.

Canadian Patent No. 2636592 discloses devices, systems, and methods to support and/or restrain a head of a patient, optionally for use in refractive surgery. Both the height of the patient’s head and the angle of the patient’s neck along the medial-lateral plane of the patient can be established independently, and compression pillow systems can gently and atraumatically compress the patient’s head between protruding foam sidewalls or the like to inhibit movement of the patient from the alignment position. The system is for restraining the patient’s head and is not designed to accurately position a patient or user’s head in preparation for a treatment.

U.S. Pat. No. 4649905 discloses a headpiece and headpiece coupling arrangement to be used in conjunction with a chiropractic treatment table, allowing the practitioner to select any one or more of five different modes of movement of the headrest relative to the main portion of the treatment table. In addition to the somewhat conventional pivotal motion about a horizontal axis the present invention provides the practitioner with pivotal motion about a vertical axis, linear extension or traction, rotation of the headpiece about a longitudinal axis coinciding with the patient’s spinal column and an abrupt limited motion for bringing a patient’s head forward and downwardly, imparting a snapping action to the cervical spine portion. This is for use as a treatment device and is not designed to accurately position a patient or user’s head in preparation for a treatment.

U.S. Pat. Application Publication No. 20020169460 discloses a head support apparatus. The apparatus may for example be used for ophthalmic examination. In some embodiments, the apparatus may allow six degrees of freedom of motion during initial positioning of a patient’s head, and may then be locked to hold the patient’s head in place precisely. The head support mechanism may include three shafts connecting an upper frame to a structure. Each shaft may be provided with a ball-and-socket joint at one end and a lockable bearing assembly on the other end. The lockable bearing assembly may provide a combination of sliding and pivotal movement. A biasing assembly may be provided to support each shaft, and to return each shaft to a self-centered and fully lifted rest position. A head clamping apparatus is also disclosed comprising pivoting clamping arms and an adjustable chin rest. This head support is designed for the patient to be face down.

What is needed is a device that allows for accurate positioning of a user’s head in relation to the rest of the body. It would be preferable if it was highly adjustable. It would be preferable if it was a stand-alone device or could be attached to a treatment table. It would be preferable if it directed the patient to the proper placement of their head. It would be preferable if it was comfortable for the patient and did not clamp or otherwise restrain the user’s head.

### SUMMARY

The present technology is a device that allows for accurate positioning of a user’s head in relation to the rest of the body. It is highly adjustable, being adjustable in the X, Y and Z axis as well as being adjustable along the roll axis, the pitch axis and the yaw axis, thus providing six degrees of freedom. It is a stand-alone device or alternatively can be attached to a treatment table. It includes a landmark pad which directs the patient to the proper placement of their head. It is comfortable for the patient and does not clamp or otherwise restrain the user’s head.

In one embodiment, a head positioner is provided for correctly positioning a patient’s head, the head positioner configured for use with a stand, the head positioner comprising: a platform which is configured to be mounted on the stand; a slider which is in slidable engagement with the platform, the slider movable longitudinally; a bracket which is mounted on the slider or is integral with the slider; and a landmark pad, the landmark pad including a pin which is in rotational engagement with the bracket, and a central depression or a central aperture for accepting a selected landmark of a patient’s head.

The head positioner may further comprise an adjustor configured for horizontal movement of the landmark pad.

In the head positioner, the landmark pad may further include an elongated wedge which is parallel to the pin.

In the head positioner, the elongated wedge may be disposed on an inner surface of the landmark pad.

In the head positioner, the landmark pad may further include a cone which is disposed on an outer surface of the landmark pad and is configured to mate with a cone-mate.

In the head positioner, the pin may be a gimballed pin.

In the head positioner, the landmark pad may be configured to accept an ear of the patient’s head.

In another embodiment, a head positioner for positioning a patient’s head is provided, the head positioner having at least five degrees of freedom, the head positioner comprising: a platform which is configured to be mounted on a stand or a treatment table; a first member configured to move along the platform on a longitudinal axis; a second member configured to move along the platform along a horizontal axis; and a landmark pad attached to the first member and the second member and configured for rotation in relation to the platform, the landmark pad including a central depression or a central aperture for accepting a selected landmark of the patient’s head.

The head positioner may further comprise a vertical adjustment member attached to the platform and configured for mounting on the treatment table.

In the head positioner, the landmark pad may further include an elongated wedge which is parallel to the pin.

In the head positioner, the elongated wedge may be disposed on an inner surface of the landmark pad.

In the head positioner, the landmark pad may further include a cone which is disposed on an outer surface of the landmark pad and is configured to mate with a cone-mate.

The head positioner may further comprise a microprocessor, the microprocessor configured to control positioning of the landmark pad.

In the head positioner, the microprocessor may include a wireless radio.

In another embodiment, a head positioning system is provided, the head positioning system comprising a vertically adjustable stand and a head positioner, the head positioner including: a platform which is mounted on the stand; a slider which is in slidable engagement with the platform, the slider movable longitudinally; a bracket which is mounted on the slider or is integral with the slider; and a landmark pad, the landmark pad including a pin which is in rotational engagement with the bracket, and a central depression or a central aperture for accepting a selected landmark of a patient’s head.

In the head positioning system, the head positioner may further comprise an adjustor configured for horizontal movement of the landmark pad.

In the head positioning system, the landmark pad of the head positioner may further include an elongated wedge which is parallel to the pin.

In the head positioning system, the elongated wedge of the head positioner may be disposed on an inner surface of the landmark pad.

In the head positioning system, the landmark pad of the head positioner may further include a cone which is disposed on an outer surface of the landmark pad and is configured to mate with a cone-mate.

In the head positioning system, the pin of the head positioner may be a gimballed pin.

In the head positioning system, the landmark pad of the head positioner may be configured to accept an ear of the patient’s head.

In another embodiment, a head positioning system is provided, the head positioning system having six degrees of freedom, and comprising a vertically adjustable stand and a head positioner, the head positioner comprising: a platform which is mounted on the stand; a first member configured to move along the platform on a longitudinal axis; a second member configured to move along the platform along a horizontal axis; and a landmark pad attached to the first member and the second member and configured for rotation in relation to the platform, the landmark pad including a central depression or a central aperture for accepting a selected landmark of the patient’s head.

The head positioner further comprises an adjustor configured for horizontal movement of the landmark pad.

In the head positioning system, the head positioner may further comprise an adjustor configured for horizontal movement of the landmark pad.

In the head positioning system, the landmark pad of the head positioner may further include an elongated wedge which is parallel to the pin.

In the head positioning system, the elongated wedge of the head positioner may be disposed on an inner surface of the landmark pad.

In the head positioning system, the landmark pad of the head positioner may further include a cone which is disposed on an outer surface of the landmark pad and is configured to mate with a cone-mate.

In the head positioning system, the pin of the head positioner may be a gimballed pin.

In the head positioning system, the landmark pad of the head positioner may be configured to accept an ear of the patient’s head.

### BRIEF DESCRIPTION OF THE DRAWINGS

FIG. 1 is a perspective view of the head positioning system of the present technology.

FIG. 2 is a perspective view of an alternative embodiment of the present technology.

FIG. 3 is a top view of the yoke or bracket with an additional slider orthogonal to the first slider.

FIG. 4 is a perspective view of another alternative embodiment.

FIG. 5 is a perspective view of another alternative embodiment.

FIG. 6 is a perspective view of another alternative embodiment.

FIG. 7 is a plan view of the landmark pad.

FIG. 8 is a perspective view of another alternative embodiment landmark pad.

FIG. 9 is a perspective view of another alternative embodiment landmark pad.

FIG. 10 is a perspective view of another alternative embodiment landmark pad.

FIG. 11 is a perspective view of another alternative embodiment landmark pad.

### DESCRIPTION

Except as otherwise expressly provided, the following rules of interpretation apply to this specification: (a) all words used herein shall be construed to be of such gender or number (singular or plural) as the circumstances require; (b) the singular terms “a”, “an”, and “the”, as used in the specification and the appended claims include plural references unless the context clearly dictates otherwise; (c) the antecedent term “about” applied to a recited range or value denotes an approximation within the deviation in the range or value known or expected in the art from the measurements method; (d) the words “herein”, “hereby”, “hereof”, “hereto”, “hereinbefore”, and “hereinafter”, and words of similar import, refer to this specification in its entirety and not to any particular paragraph, claim or other subdivision, unless otherwise specified; (e) descriptive headings are for convenience only and shall not control or affect the meaning or construction of any part of the specification; and (f) “or” and “any” are not exclusive and “include” and “including” are not limiting. Further, the terms “comprising,” “having,” “including,” and “containing” are to be construed as open-ended terms (i.e., meaning “including, but not limited to,”) unless otherwise noted.

Recitation of ranges of values herein are merely intended to serve as a shorthand method of referring individually to each separate value falling within the range, unless otherwise indicated herein, and each separate value is incorporated into the specification as if it were individually recited herein. Where a specific range of values is provided, it is understood that each intervening value, to the tenth of the unit of the lower limit unless the context clearly dictates otherwise, between the upper and lower limit of that range and any other stated or intervening value in that stated range, is included therein. All smaller sub ranges are also included. The upper and lower limits of these smaller ranges are also included therein, subject to any specifically excluded limit in the stated range.

Unless defined otherwise, all technical and scientific terms used herein have the same meaning as commonly understood by one of ordinary skill in the relevant art. Although any methods and materials similar or equivalent to those described herein can also be used, the acceptable methods and materials are now described.

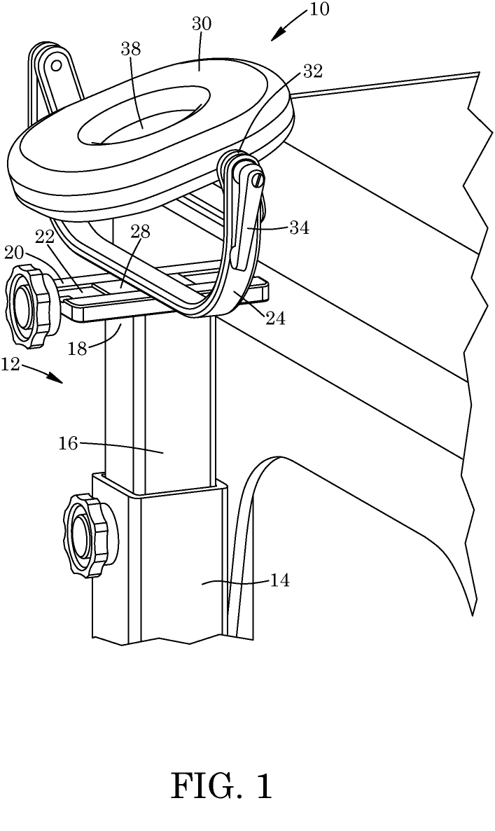

A head positioning system, generally referred to as 10, is shown in FIG. 1. It includes a stand, generally referred to as 12, which has a sleeve 14 and arm 16 adjustably housed therein. The stand 12 allows for vertical adjustment through a telescoping action. At the proximal end 18 of the stand 12 a platform 20 is mounted. The platform 20 includes a slide 22. A yoke 24 is in slidable engagement with the slide 22 allowing for movement along a longitudinal axis. To this end, the yoke includes a slider 28. The yoke 24 retains a landmark pad 30. The landmark pad 30 includes a pin 32 which is releasably retained by the yoke 24 with a lever 34. When the lever 34 is loosened, the landmark pad 30 can be tilted up and down about a horizontal axis (the pitch axis). The landmark pad 30 is shaped as an elongated doughnut, with a central aperture 38 or central depression.

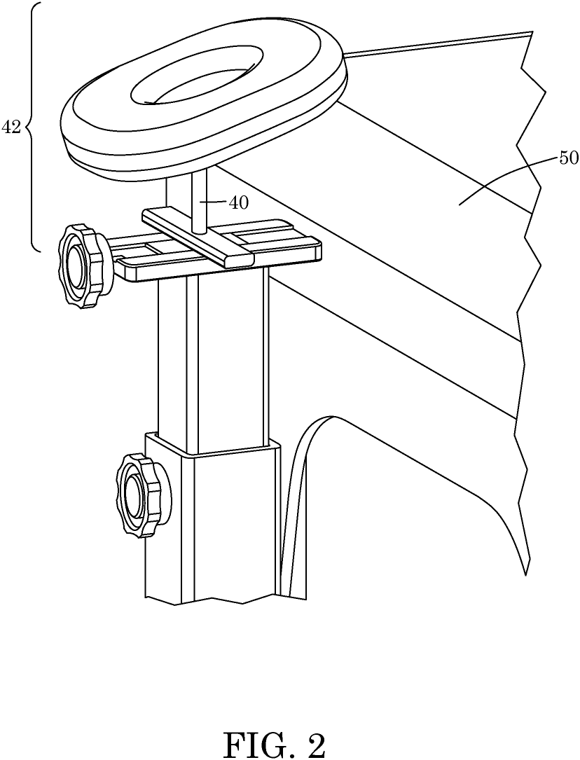

As shown in FIG. 2, in one embodiment, the pin 32 is replaced with a gimballed pin 40. The gimballed pin 40 allows for rotational adjustment about the longitudinal axis (the roll axis), about the horizontal axis (the pitch axis) and about the vertical axis (the yaw axis). The platform 20, yoke 24 and landmark pad 30 are collectively referred to as the head positioning device 42. The head positioning system 10 is located proximate to a treatment table 50 but is independent of the treatment table 50.

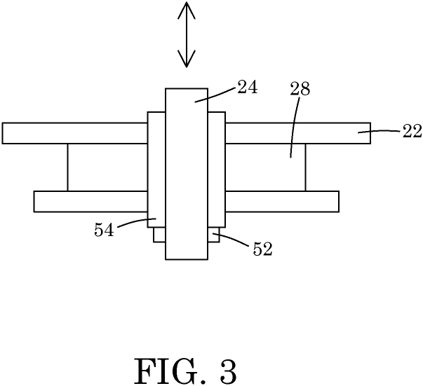

As shown in FIG. 3, in another embodiment, an additional adjustor 52 is provided that allows for movement along the horizontal axis. A second slide 54 allows for the movement. Thus, between the stand 12 and the head positioning device 42, the head positioning system 10 provides six degrees of freedom.

As shown in FIG. 4, in another embodiment, a head positioning device 142 has six degrees of freedom. The head positioning device 142 has the additional adjustor 52 for movement along the horizontal axis and also has a vertical adjustor 144 for up and down adjustment. The yoke 24 includes a sleeve 146 and an arm 148 slidably engaged therein.

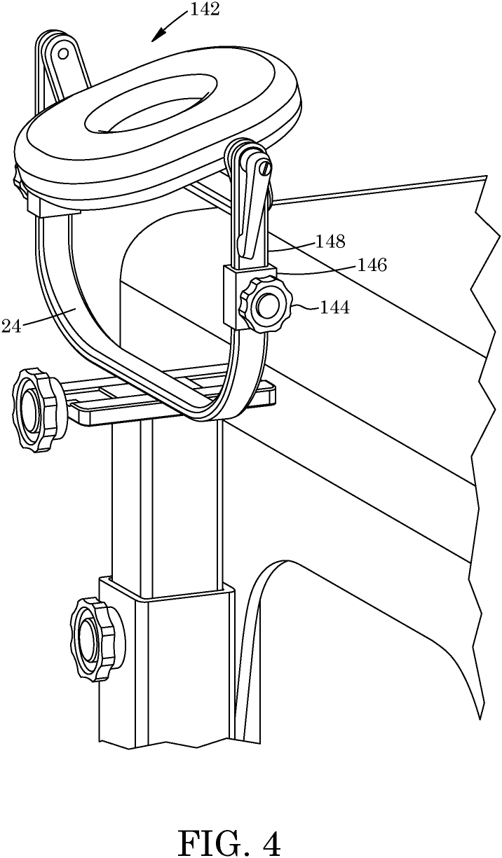

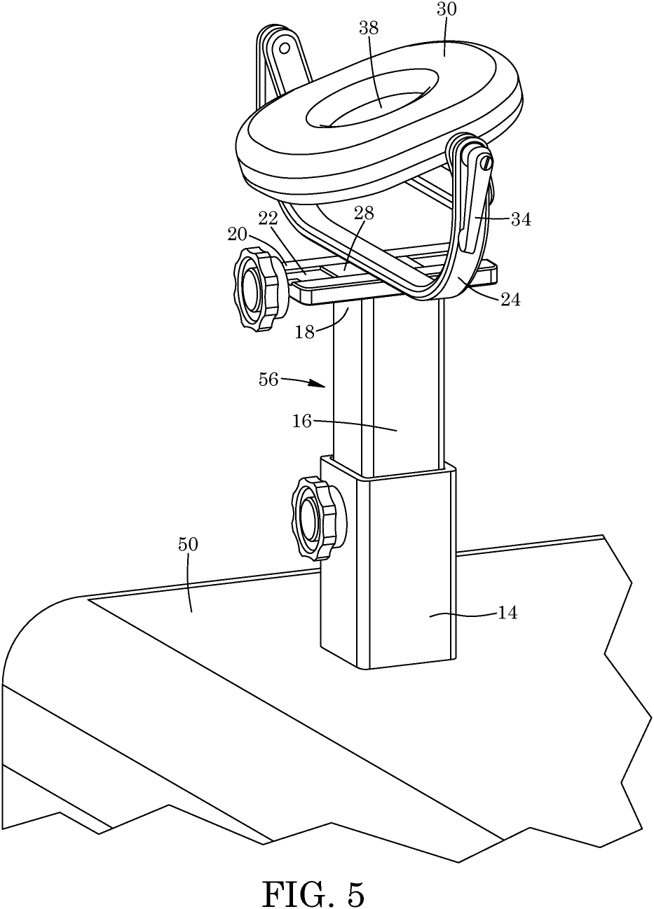

In another embodiment, as shown in FIG. 5, the head positioning device 42 is integrated into the treatment table 50. Vertical adjustment is effected with a telescoping member, generally referred to as 56 on the treatment table 50. As in the first embodiment, at the proximal end 18 of the telescoping member 56 a platform 20 is mounted. The platform 20 includes a slide 22. A yoke or bracket 24 is in slidable engagement with the slide 22 allowing for movement along a longitudinal axis. To this end, the yoke 24 includes a slider 26. The yoke 24 retains a landmark pad 30. The landmark pad 30 includes a pin 32 which is releasably retained by the yoke 24 with a lever 34. When the lever 34 is loosened, the landmark pad 30 can be tilted up and down about a horizontal axis 36. The landmark pad 30 is shaped as an elongated doughnut, with a central aperture 38 or central depression.

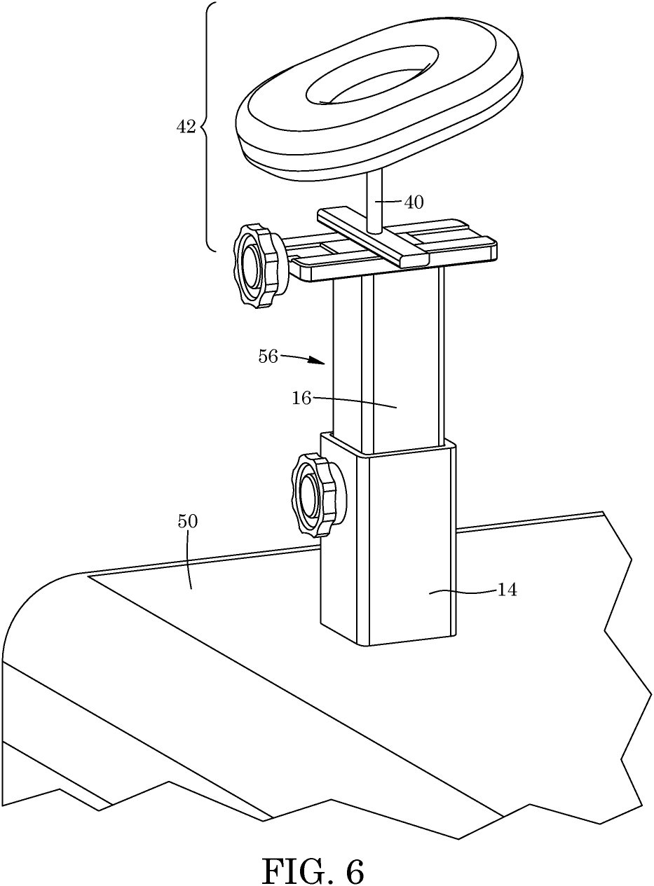

In another embodiment of the integrated system, as shown in FIG. 6, the head positioning device 42 is integrated into the treatment table 50. The pin 32 is replaced with a gimballed pin 40. The gimballed pin 40 allows for rotational adjustment about the longitudinal axis (the roll axis), about the horizontal axis (the pitch axis) and about the vertical axis (the yaw axis). The platform 20, yoke 24 and landmark pad 30 are collectively referred to as the head positioning device 42.

In another embodiment of the integrated system, an additional adjustor 52 is provided that allows for movement along the horizontal axis (as is shown for the floor mounted stand version of FIG. 3). A second slide 54 allows for the movement. Thus, between the treatment table 50 and the head positioning device 42, there are six degrees of freedom.

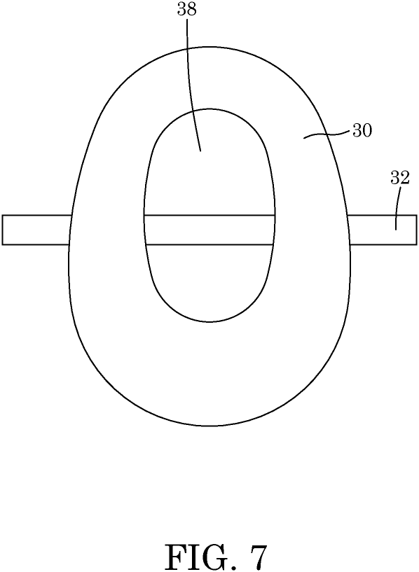

The details of the landmark pad 30 are shown in FIG. 7. The landmark pad 30 is designed to support the user’s head both in a face down position and in a face to the side position. The ear of the user should be located in the central aperture 38 or central depression when the user is on their side. The landmark of interest in one embodiment is the ear, and more specifically the tragus.

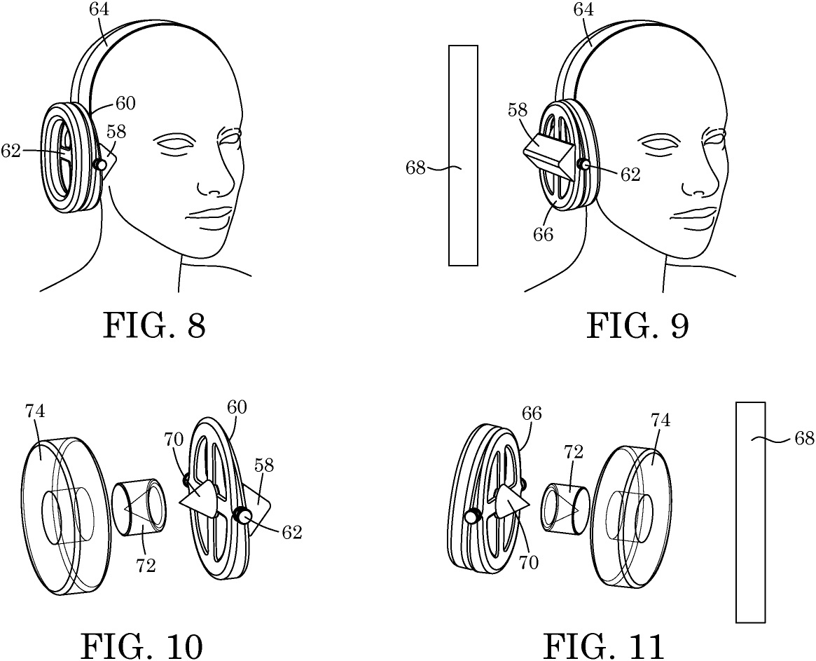

In another embodiment, as shown in FIG. 8, the landmark pad 30 includes an elongated wedge 58 on the inner surface 60 of the landmark pad 30. It parallels a pin 62 which retains a headband 64. The wedge 58 acts as a pivot point on the patient’s tragus. In another embodiment, the elongated wedge 58 parallels the pin 32 which is releasably retained by the yoke 24.

In another embodiment, as shown in FIG. 9, the landmark pad 30 includes an elongated wedge 58 on the outer surface 66 of the landmark pad 30. It parallels the pin 62 which retains the headband 64. The wedge 58 acts as a pivot point at the contact point with the treatment table headrest 68, hence any positioning other than the tilt of the landmark pad 30 is a function of the treatment table 50 and/or the treatment table headrest 68. In another embodiment, the wedge 58 parallels the pin 32 which is releasably retained by the yoke 24.

In another embodiment, as shown in FIG. 10, the landmark pad 30 includes a cone 70 centrally located on the outer surface 66 of the landmark pad 30. The cone 70 releasably mates with a cone mate 72 which is mounted on the treatment table headrest 68 with a mounting plate 74. The cone 70, cone mate 72 and mounting plate 74 form the connection between the patient’s head and the treatment table headrest 68, hence any positioning is a function of the treatment table 50 and/or the treatment table headrest 68.

In another embodiment, as shown in FIG. 11, both the elongated wedge 58 and the cone 70-cone mate 72 combination are included in the landmark pad 30. The elongated wedge 58 is on the inner surface 60 of the landmark pad 30. It parallels the pin 62 which retains the headband 64 as is shown in FIG. 8. The wedge 58 acts as a pivot point on the patient’s tragus. In another embodiment, the elongated wedge 58 parallels the pin 32 which is releasably retained by the yoke 24.

In one embodiment the stand 12 and the telescoping member 54 include one or more of a hydraulic actuator, a pneumatic actuator, and a spring to assist in vertical adjustment.

In one embodiment, the head positioning system 10 is automated. A microprocessor controls adjustment of the system 10. The microprocessor may include a wireless receiver and therefore, the practitioner can set the adjustments by communicating wirelessly to the microprocessor via a computing device.

In one embodiment the head positioning device 42 and the telescoping member 54 are automated. A microprocessor controls adjustment. The microprocessor may include a wireless receiver and therefore, the practitioner can set the adjustments by communicating wirelessly to the microprocessor via a computing device.

The following is a list of the functions of both the head positioning system 10 and the head positioning device 42 with telescoping member 54:
Support head during treatment to the cervical (C) spine, and C1 region;
Support head when patient is face down for other bodily treatments;
Pivot head using tragus as pivot point;
Provide tragus adjustments of 0.5 cm increments within a ± 3 cm range; and
Allow 6 degrees of freedom (X, Y and Z [longitudinal, horizontal, and vertical] and pitch, yaw and roll).

The following is a list of the functions of the head positioning device 42:
Support head during treatment to the cervical (C) spine, and C1 region;
Support head when patient is face down for other bodily treatments;
Pivot head using tragus as pivot point;
Provide tragus adjustments of 0.5 cm increments within a ± 3 cm range; and
In one embodiment, allow 5 degrees of freedom (X and Y [longitudinal and horizontal] and pitch, yaw and roll).

In another embodiment, the head positioning device 142 allows for 6 degrees of freedom (X, Y and Z [longitudinal, horizontal, and vertical] and pitch, yaw and roll).

While example embodiments have been described in connection with what is presently considered to be an example of a possible most practical and/or suitable embodiment, it is to be understood that the descriptions are not to be limited to the disclosed embodiments, but on the contrary, is intended to cover various modifications and equivalent arrangements included within the spirit and scope of the example embodiment. Those skilled in the art will recognize or be able to ascertain using no more than routine experimentation, many equivalents to the specific example embodiments specifically described herein. Such equivalents are intended to be encompassed in the scope of the claims, if appended hereto or subsequently filed.

1. A head positioner for use with a stand, the head positioner comprising: a platform which is configured to be mounted on the stand; a slider which is in slidable engagement with the platform, the slider movable longitudinally; a bracket which is mounted on the slider or is integral with the slider; and a landmark pad, the landmark pad including a pin which is in rotational engagement with the bracket, and a central depression or a central aperture for accepting a selected landmark of a patient’s head.

2. The head positioner of claim 1, further comprising an adjustor configured for horizontal movement of the landmark pad.

3. The head positioner of claim 2, wherein the landmark pad further includes an elongated wedge which is parallel to the pin.

4. The head positioner of claim 3, wherein the elongated wedge is disposed on an inner surface of the landmark pad.

5. The head positioner of claim 4, wherein the landmark pad further includes a cone which is disposed on an outer surface of the landmark pad and is configured to mate with a cone-mate.

6. The head positioner of claim 5, wherein the pin is a gimballed pin.

7. The head positioner of claim 6, wherein the landmark pad is configured to accept an ear of the patient’s head.

8. A head positioner for positioning a patient’s head, the head positioner having at least five degrees of freedom, the head positioner comprising: a platform which is configured to be mounted on a stand or a treatment table; a first member configured to move along the platform on a longitudinal axis; a second member configured to move along the platform along a horizontal axis; and a landmark pad attached to the first member and the second member and configured for rotation in relation to the platform, the landmark pad including a central depression or a central aperture for accepting a selected landmark of the patient’s head.

9. The head positioner of claim 8, further comprising a vertical adjustment member attached to the platform and configured for mounting on the treatment table.

10. The head positioner of claim 9, wherein the landmark pad further includes an elongated wedge which is parallel to the pin.

11. The head positioner of claim 10, wherein the elongated wedge is disposed on an inner surface of the landmark pad.

12. The head positioner of claim 11, wherein the landmark pad further includes a cone which is disposed on an outer surface of the landmark pad and is configured to mate with a cone-mate.

13. The head positioner of claim 12, further comprising a microprocessor, the microprocessor configured to control positioning of the landmark pad.

14. The head positioner of claim 13, wherein the microprocessor includes a wireless radio.

15. A head positioning system, the head positioning system comprising a vertically adjustable stand and a head positioner, the head positioner including: a platform which is mounted on the stand; a slider which is in slidable engagement with the platform, the slider movable longitudinally; a bracket which is mounted on the slider or is integral with the slider; and a landmark pad, the landmark pad including a pin which is in rotational engagement with the bracket, and a central depression or a central aperture for accepting a selected landmark of a patient’s head.

16. The head positioning system of claim 15, wherein the head positioner further comprises an adjustor configured for horizontal movement of the landmark pad.

17. The head positioning system of claim 15, wherein the landmark pad of the head positioner further includes an elongated wedge which is parallel to the pin.

18. The head positioning system of claim 17, wherein the elongated wedge of the head positioner is disposed on an inner surface of the landmark pad.

19. The head positioning system of claim 18, wherein the landmark pad of the head positioner further includes a cone which is disposed on an outer surface of the landmark pad and is configured to mate with a cone-mate.

20. A head positioning system, the head positioning system having six degrees of freedom, and comprising a vertically adjustable stand and a head positioner, the head positioner comprising: a platform which is mounted on the stand; a first member configured to move along the platform on a longitudinal axis; a second member configured to move along the platform along a horizontal axis; and a landmark pad attached to the first member and the second member and configured for rotation in relation to the platform, the landmark pad including a central depression or a central aperture for accepting a selected landmark of the patient’s head.
